(19) United States
(12) Patent Application Publication
(10) Pub. No.: US 2017/0171665 A1
(43) Pub. Date: Jun. 15, 2017

(54) SPEAKER DEVICE

(71) Applicant: JVC KENWOOD Corporation, Yokohama-shi (JP)

(72) Inventor: Kazushi KUROYANAGI, Yokohama-shi (JP)

(21) Appl. No.: 15/375,889

(22) Filed: Dec. 12, 2016

(30) Foreign Application Priority Data
Dec. 14, 2015 (JP) 2015-243089

(51) Int. Cl. H04R 9/06; H04R 9/04; H04R 7/18; H04R 1/02; H04R 7/12

(52) U.S. Cl. CPC H04R 9/06; H04R 1/025; H04R 7/127; H04R 7/18; H04R 9/043

(57) ABSTRACT

The speaker device includes: a voice coil bobbin around which a voice coil is wound; a diaphragm; a surround including an outer circumferential end portion extending in a direction that crosses the sound emission direction from which sound is emitted by the diaphragm; a spider with an inner circumferential end portion bonded to the voice coil bobbin; and a frame including a flat section. The spider includes an accordion section, a rising section which rises toward the diaphragm; and a bent section extending in the direction that crosses the sound emission direction. The outer circumferential end portion of the surround and the bent section of the spider are bonded to the flat section with an adhesive.

### CROSS REFERENCE TO RELATED APPLICATION

This application is based upon and claims the benefit of priority under 35 U.S.C. §119 from Japanese Patent Application No. 2015-243089 filed on Dec. 14, 2015, the entire contents of which are incorporated herein by reference.

### BACKGROUND

The present disclosure relates to a speaker device that can improve in reliability.

A speaker device is composed of plural components which are bonded with an adhesive. If a speaker device operates for a long time, the temperature of the speaker device rises. Some speaker devices are used in high-temperature environments, and the temperature thereof sometimes rises, depending on the external environment.

### SUMMARY

One of the parts constituting a speaker device is a spider that couples a voice coil bobbin and a frame. One of the end portions of the spider is bonded to the voice coil bobbin with adhesive, while the other end portion is bonded to the frame.

When the temperature of the speaker device increases, the bonded portion of the spider and frame may break due to deterioration of the adhesive that bonds the spider and frame, making the speaker device unusable. To improve the reliability of the speaker device, therefore, it is required to prevent breakage at the bonded portion of the spider and frame even when the temperature of the speaker device rises.

An aspect of the embodiments provides a speaker device, including: a voice coil bobbin around which a voice coil is wound; a diaphragm with an inner circumferential end portion bonded to the voice coil bobbin; a surround with an inner circumferential end portion bonded to an outer circumferential end portion of the diaphragm, including an outer circumferential end portion which extends in a direction that crosses the direction in which sound is emitted from the diaphragm; a spider including: an accordion section located radially inside with an inner circumferential end portion bonded to the voice coil bobbin; a rising section which is located radially outside of the accordion section and rises from an outer circumferential end portion of the accordion section towards the diaphragm; and a bent section which is located radially outside of the rising section and extends in the direction that crosses the sound emission direction; and a frame including a flat section which extends in the direction that crosses the sound emission direction, and to which the outer circumferential end portion of the surround and the bent section of the spider are bonded with an adhesive.

### BRIEF DESCRIPTION OF THE DRAWINGS

FIG. 1 is a cross-sectional view illustrating a speaker device according to at least one embodiment.

FIG. 2 is an enlarged cross-sectional view of a part of the speaker device according to the embodiment.

### DETAILED DESCRIPTION

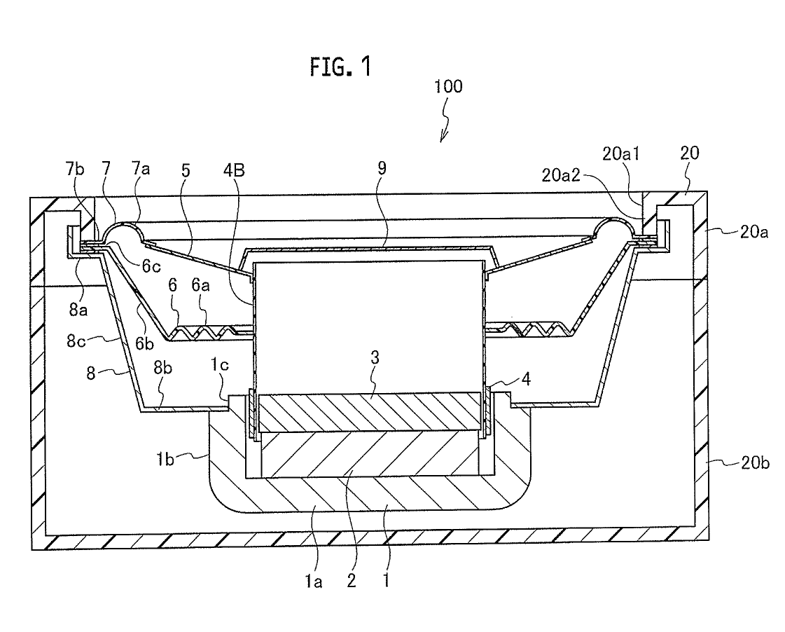

Hereinafter, a description is given of a speaker device according to the embodiment with reference to the accompanying drawings. FIG. 1 illustrates the entire configuration of a speaker device 100 according to the embodiment.

In FIG. 1, a yoke 1 having a U-shaped cross-section includes a circular bottom section 1a and a side section 1b circumferentially surrounding the periphery of the bottom section 1a. The yoke 1 is made of metal such as iron. On the bottom section 1a, a circular magnet 2 is bonded. On the magnet 2, a circular top plate 3 is bonded. The top plate 3 is made of metal such as iron.

Between the side section 1b of the yoke 1 and the magnet 2 and top plate 3, a gap having a predetermined distance is provided.

In the gap between the side section 1b, and the magnet 2 and top plate 3, the lower portion of a cylindrical voice coil bobbin 4B is inserted. The voice coil bobbin 4B is made of plastic resin, for example. A voice coil 4, which is composed of copper wire, for example, is wound around the lower portion of the voice coil bobbin 4B.

The lower end portion of the voice coil bobbin 4B faces the upper end portion of the magnet 2 when the voice coil 4 is not supplied with an audio signal. The voice coil 4 is located between the side section 1b and top plate 3 when the voice coil 4 is not supplied with an audio signal.

The yoke 1, the magnet 2, the top plate 3, and the voice coil 4 constitute a magnetic circuit.

The inner circumferential end portion of a diaphragm 5 is fixed in the vicinity of the upper end portion of the voice coil bobbin 4B. The diaphragm 5 is made of any one of paper, plastic resin, wood, metal, carbon fiber, and the like.

To the outer circumferential end portion of the diaphragm 5, an inner circumferential end portion of a surround 7 is bonded. The surround 7 includes a curved section 7a, having a semicircular cross section and an outer circumferential end portion 7b located radially outside of the curved section 7a. The outer circumferential end portion 7b extends in a direction that (orthogonally) crosses a sound emission direction. The sound emission direction refers to the direction in which sound emits from the diaphragm 5. The sound emission direction is the upward direction in FIG. 1. The surround 7 is made of synthetic resin (rubber) or fiber (cloth), for example.

In the middle of the voice coil bobbin 4B, the inner circumferential end portion of a spider 6 is bonded by an acrylic adhesive, for example. The joined part of the voice coil bobbin 4B and the inner circumferential end portion of the spider 6 is filled and fixed with the adhesive. The bonded part of the spider 6 and the voice coil bobbin 4B is therefore comparatively less likely to be damaged due to deterioration even when the temperature increases.

The spider 6 includes an accordion section 6a, a rising section 6b, and a bent section 6c. The accordion section 6a is located radially inside and has an accordion-like shape. The rising section 6b is located radially outside of the accordion section 6a, and extends upward from the outer circumferential end portion of the accordion section 6a. The bent section 6c is located radially outside of the rising section 6b. The bent section 6c extends in the direction that (orthogonally) crosses the sound emission direction. The spider 6 is made of plastic resin, for example.

The outer circumferential end portion 7b of the surround 7 and the bent section 6c of the spider 6 are bonded to a flat section 8a, which is formed near the upper end portion of a metallic frame 8 as described later in detail. The flat section 8a extends in the direction that (orthogonally) crosses the sound emission direction and has a flange shape.

The frame 8 includes a flat section 8b formed in the lower end portion. The flat section 8b also has a flange shape so as to (orthogonally) cross the sound emission direction. In the middle section 8c between the flat sections 8a and 8b in the frame 8, plural openings are provided at predetermined intervals in the circumferential direction (not illustrated).

The inner circumferential end portion of the flat section 8b abuts on a cut-off section 1c, which is formed in the upper end portion of the yoke 1.

At the center of the diaphragm 5, a center cap 9 is bonded to cover a circular opening formed at the center of the diaphragm 5. The center cap 9 is made of plastic resin, for example.

When an audio signal is supplied to the voice coil 4, the voice coil bobbin 4B vibrates up and down. The diaphragm 5 vibrates with the vibration of the voice coil bobbin 4B. The diaphragm 5 emits sound corresponding to the supplied audio signal.

The speaker device 100 includes a case 20. The speaker device 100 does not need to include the case 20. The case 20 houses all of the yoke 1, magnet 2, top plate 3, voice coil 4, voice coil bobbin 4B, diaphragm 5, spider 6, surround 7, frame 8, and center cap 9.

The case 20 is composed of upper and lower cases 20a and 20b. The case 20 is made of plastic resin, for example. The upper case 20a is fixed to the flat section 8a with screws, for example.

Each of the upper and lower cases 20a and 20b has a rectangular prism shape having a square view in the sound emission direction or in the opposite direction thereto, a cylindrical shape, or the like, for example. The upper case 20a includes a circular opening 20a1 so that the diaphragm 5 is exposed to the outside. The upper case 20a may be provided with a top board, including plural openings, so as to protect the diaphragm 5 and allow sound to emit from the speaker device 100.

At the opening 20a1 side edge of the upper case 20a, a protrusion 20a2 is formed. The protrusion 20a2 protrudes toward the bottom of the speaker device 100. The protrusion 20a2 extends in the direction opposite to the sound emission direction.

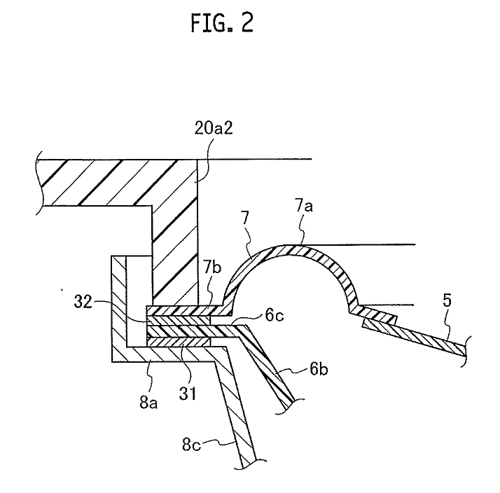

Herein, using FIG. 2, a description is given of the structure in which the outer circumferential end portion 7b of the surround 7 and the bent section 6c of the spider 6 are bonded to the flat section 8a.

As illustrated in FIG. 2, the bent section 6c is bonded to the flat section 8a by an adhesive 31. The outer circumferential end portion 7b is bonded to the bent section 6c by an adhesive 32. The adhesives 31 and 32 are rubber adhesives widely used for in-vehicle speakers.

The flat section 8a is located away from the magnetic circuit and near the outside of the speaker device 100. The temperature of the flat section 8a is therefore less likely to rise, especially when the speaker device 100 is used in an environment where the sound emission direction side of the speaker device 100 is exposed to wind. The adhesives 31 and 32 are less likely to deteriorate.

It is therefore possible to reduce the likelihood that the spider 6 is separated from the frame 8 due to damage of the bonded portion of the bent section 6c and flat section 8a.

In the configuration where the speaker device 100 includes the case 20, the protrusion 20a2 and flat portion 8a sandwich the bent portion 6c and outer circumferential end portion 7b. Accordingly, in the configuration where the speaker device 100 includes the case 20, it is possible to significantly reduce the likelihood that the spider 6 is separated from the frame 8.

It is preferable that the protrusion 20a2 presses the flat section 8a with the bent section 6c and outer circumferential end portion 7b interposed therebetween when the upper case 20a is engaged with the lower case 20b which houses the components constituting the speaker device 100. Preferably, the relationship in size between the case 20 and housed components is configured so that the protrusion 20a2 presses the flat section 8a.

The speaker device 100 illustrated in FIG. 1 is a so-called internal magnetic type speaker. The speaker device 100 may be an external magnetic type speaker.

As described above, in accordance with the speaker device 100 according to the embodiment, it is possible to prevent breakage at the bonded portion of the spider 6 and frame 8 even when the temperature of the speaker device 100 rises, and the reliability of the speaker device 100 is improved.

When the reliability of the speaker device 100 is improved, the input voltage of the speaker device 100 can be increased, so that the speaker device 100 can generate a larger volume of sound. Moreover, the adhesives 31 and 32 do not need to have very high heat insulation, which leads to reduction in cost.

The present invention is not limited to the embodiments described above, and can be variously changed without departing from the scope of the invention.

What is claimed is:

1. A speaker device, comprising:
a voice coil bobbin around which a voice coil is wound;
a diaphragm with an inner circumferential end portion bonded to the voice coil bobbin;
a surround with an inner circumferential end portion bonded to an outer circumferential end portion of the diaphragm, including an outer circumferential end portion which extends in a direction that crosses the direction in which sound is emitted from the diaphragm;
a spider including: an accordion section located radially inside with an inner circumferential end portion bonded to the voice coil bobbin; a rising section which is located radially outside of the accordion section and rises from an outer circumferential end portion of the accordion section towards the diaphragm; and a bent section which is located radially outside of the rising section and extends in the direction that crosses the sound emission direction; and
a frame including a flat section which extends in the direction that crosses the sound emission direction, and to which the outer circumferential end portion of the surround and the bent section of the spider are bonded with an adhesive.

2. The speaker device according to claim 1, further comprising a case housing the voice coil bobbin, the diaphragm, the surround, the spider, and the frame, the case including a protrusion extending in a direction opposite to the sound emission direction, wherein
the protrusion and the flat section of the frame sandwich the outer circumferential end portion of the surround and the bent section of the spider.
